(19) United States
(12) Patent Application Publication
(10) Pub. No.: US 2009/0040187 A1
(43) Pub. Date: Feb. 12, 2009

(54) PORTABLE DEVICE AND METHOD FOR RAPIDLY POSITIONING CURSOR

(75) Inventors: Po-Kai KO, Taipei (TW); Chi-Chung HO, Taipei (TW)

Correspondence Address: Muncy, Geissler, Olds & Lowe, PLLC, P.O. BOX 1364, FAIRFAX, VA, 22038-1364, US

(73) Assignee: ASUSTEK COMPUTER INC.

(21) Appl. No.: 12/129,290

(22) Filed: May 29, 2008

(30) Foreign Application Priority Data
Aug. 9, 2007 (TW) 096129460

(51) Int. Cl. G06F 3/041

(52) U.S. Cl. 345/173

(57) ABSTRACT

A portable device has a first and a second area. The portable device includes a flat display module disposed at the first area and having a display area with a plurality of first coordinate positions, a touch pad module disposed at the second area and having a touch pad with a plurality of second coordinate positions corresponding to the first coordinate positions respectively, and a coordinate transformation module. The flat display module displays a cursor at the first coordinate position of the display area according to a cursor position signal. The touch pad module senses the second coordinate position that an object presses at the touch pad and then generates a touch position signal. The coordinate transformation module transforms the touch position signal to the cursor position signal. According to the cursor position signal, the cursor is displayed at the first coordinate position corresponding to the second coordinate position.

### CROSS REFERENCE TO RELATED APPLICATIONS

This Non-provisional application claims priority under 35 U.S.C. §119(a) on Patent Application No(s). 096129460 filed in Taiwan, Republic of China on Aug. 9, 2007, the entire contents of which are hereby incorporated by reference.

### BACKGROUND OF THE INVENTION

1. Field of Invention

The invention relates to a portable device and a method for rapidly positioning a cursor.

2. Related Art

Along with the progress of the science and technology, a portable device is broadly applied. To allow a user to simply operate an electronic device, simple man-machine interfaces are developed. In the present, the portable device often uses a touch pad as the man-machine interface.

As shown in FIG. 1, a conventional notebook computer 1 has a flat display module 11, a keyboard 12 and a touch pad module 13. The flat display module 11 is disposed at a casing 14, and the keyboard 12 and the touch pad module 13 are disposed at another casing 15. The two casings 14 and 15 are pivotally connected to each other.

The flat display module 11 has a display area 111, and the display area 111 displays a cursor CS1 to allow the user to know where the cursor is. How to move the cursor CS1 to a needed position is illustrated hereinbelow. At first the cursor CS1 is located at a cursor position C11 at the top-right of the display area 111. When a user wants to move the cursor CS1 to a cursor position C12 at the bottom-left of the display area 111, he or she needs to press the touch pad module 13 by his or her finger. For example, the user presses a pressing position P11 shown in FIG. 1, and then he or she moves his or her finger toward the bottom-left. Therefore, the cursor CS1 begins to move from the cursor position C11 along the movement direction of the finger. However, the user needs to move his or her finger back and forth on the touch pad module 13 many times to make the cursor CS1 stop at the cursor position C12.

In this way, the user needs to continuously move his or her finger back and forth, which is inconvenient in usage. If the finger of the user is located at the pressing position P12 at first, since the space for moving the finger from the pressing position P12 to the bottom-left is small, it causes the user's trouble.

### SUMMARY OF THE INVENTION

The objective of the invention is to provide a portable device and a method for rapidly positioning a cursor to rapidly position a cursor and enhance the usage performance.

To achieve the above objective, a portable device of the invention has a first area and a second area. The portable device includes a flat display module, a touch pad module and a coordinate transformation module. The flat display module is disposed at the first area, and it has a display area. The display area has a plurality of first coordinate positions, and a cursor is displayed at the first coordinate position of the display area according to a cursor position signal. The touch pad module is disposed at the second area, and it has a touch pad. The touch pad has a plurality of second coordinate positions, and the first coordinate positions are corresponding to the second coordinate positions, respectively, according to the corresponding positions of the display area and the touch pad. When the touch pad module senses that an object presses the second coordinate position of the touch pad, it generates a touch position signal. The coordinate transformation module transforms the touch position signal to the cursor position signal. The flat display module displays the cursor at the first coordinate position corresponding to the second coordinate position according to the cursor position signal.

To achieve the above objective, a method for rapidly positioning a cursor of the invention is applied to a portable device having a touch pad and a display area. The display area has a plurality of first coordinate positions, and the touch pad has a plurality of second coordinate positions. The first coordinate positions are corresponding to the second coordinate positions, respectively, according to the corresponding positions of the display area and the touch pad. The method for rapidly positioning a cursor includes the steps of sensing the second coordinate position that an object presses at the touch pad to generate a touch position signal, transforming the touch position signal to a cursor position signal and displaying the cursor at the first coordinate position corresponding to the second coordinate position according to the cursor position signal.

In a portable device and a method for rapidly positioning a cursor of the invention, first coordinate positions of a display area are corresponding to second coordinate positions of a touch pad, and a coordinate transformation module is used to transform a touch position signal to a cursor position signal. In this way, when a user wants to move the cursor to a predetermined position, he only needs to press a position corresponding to the predetermined position on the touch pad, and then the cursor can be directly moved to the predetermined position. Compared with the conventional technology, the invention allows the user to rapidly position the cursor via the coordinate transformation module, and the user does not need to move his finger back and forth. Therefore, the usage performance increases. Furthermore, since the coordinate transformation module of the invention can transform a touch position to a cursor position, as for an electronic device, the size of the touch pad module does not need to be equal to the size of the flat display module. The size of the touch pad module may be smaller than the size of the flat display module to reduce the cost.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram showing a conventional notebook computer;

FIG. 2 is a schematic diagram showing a portable device according to a preferred embodiment of the invention;

FIG. 3 is a block diagram showing a portable device according to a preferred embodiment of the invention;

FIG. 4 is a flow chart showing a method for rapidly positioning a cursor according to a preferred embodiment of the invention;

FIG. 5 is a schematic diagram showing a display area and a touch pad of a portable device according to a preferred embodiment of the invention;

FIG. 6 is an exploded diagram showing a touch pad module of a portable device according to a preferred embodiment of the invention; and

FIG. 7 is a sectional view showing a touch pad module of a portable device according to a preferred embodiment of the invention.

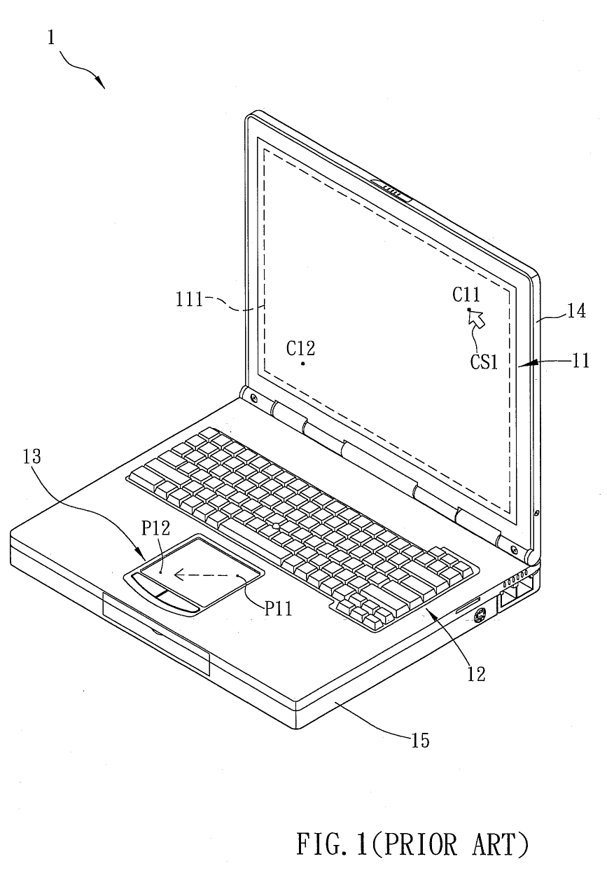

### DETAILED DESCRIPTION OF THE INVENTION

The present invention will be apparent from the following detailed description, which proceeds with reference to the accompanying drawings, wherein the same references relate to the same elements.

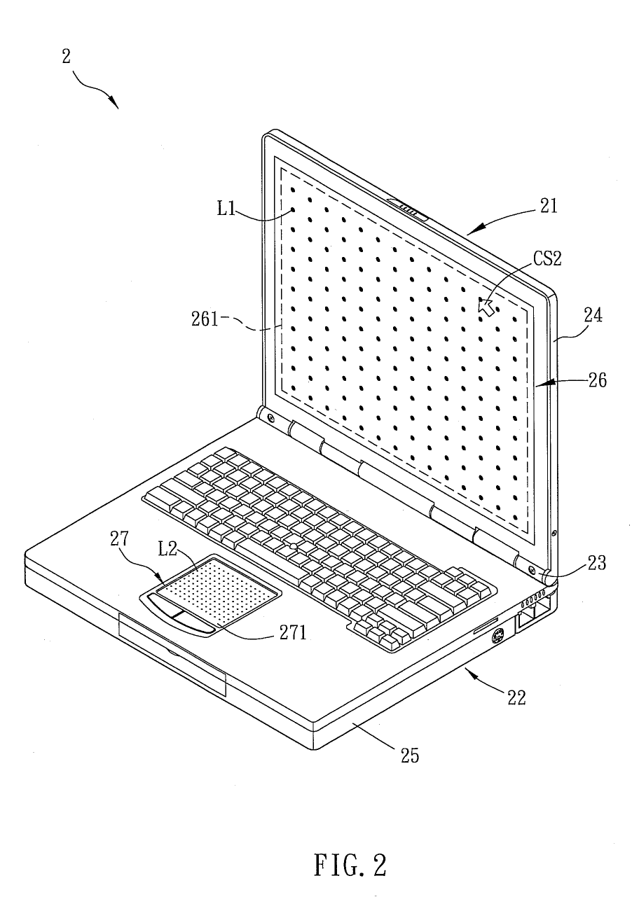

As shown in FIG. 2, a portable device 2 of a preferred embodiment of the invention is a notebook computer. The portable device 2 also may be other electronic device such as a palmtop or a mobile phone. The portable device 2 has two casings 21 and 22 and a pivot unit 23. The casings 21 and 22 are pivotally connected to the pivot unit 23 and can be opened or closed via the pivot unit 23.

The portable device 2 includes a first area 24, a second area 25, a flat display module 26 and a touch pad module 27. The first area 24 is located at the casing 21, and the second area 25 is located at the casing 22. The flat display module 26 is disposed at the first area 24, and it has a display area 261. The display area 261 has a plurality of first coordinate positions L1, and the flat display module 26 can display a cursor CS2 at one of the first coordinate positions L1 of the display area 261 according to a cursor position signal. The area of the display area 261 may be changed according to different operation modes of the portable device 2.

The touch pad module 27 is disposed at the second area 25, and it has a touch pad 271. The touch pad 271 is exposed outside the casing 22 for a user to press. The touch pad 271 has a plurality of second coordinate positions L2, and each of the second coordinate positions L2 is corresponding to one of the first coordinate positions L1.

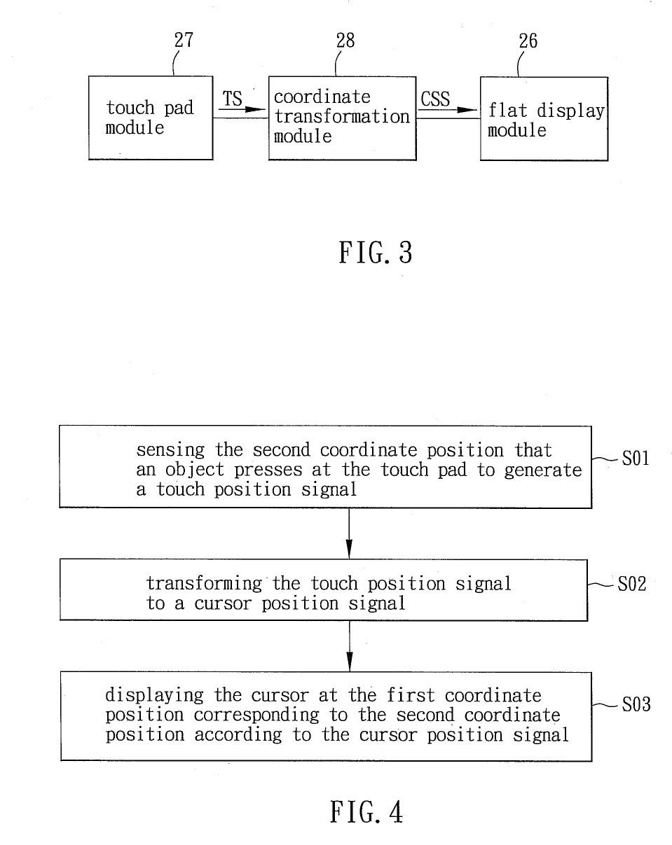

As shown in FIG. 3, the portable device 2 further includes a coordinate transformation module 28, and the coordinate transformation module 28 is electrically connected to the touch pad module 27 and the flat display module 26, respectively. The touch pad module 27 can generate a touch position signal TS according to one of the second coordinate positions L2 that an object presses at the touch pad 271, and it transmits the touch position signal TS to the coordinate transformation module 28. The coordinate transformation module 28 transforms the touch position signal TS to a cursor position signal CSS. The flat display module 26 can display the cursor CS2 at the first coordinate position L1 corresponding to the pressed second coordinate position L2 according to the cursor position signal CSS.

FIG. 4 is a flow chart showing a method for rapidly positioning a cursor according to a preferred embodiment of the invention. The method for rapidly positioning a cursor of the embodiment includes the steps S01 to S03. The method for rapidly positioning a cursor is illustrated with FIG. 2 to FIG. 4 hereinbelow.

In the step S01, the second coordinate position L2 of the touch pad 271 that an object presses is sensed, and then a touch position signal TS is generated. For example, when a user presses the touch pad 271, the touch pad 271 generates the touch position signal TS, and the touch position signal TS is corresponding to the position that the user presses, namely one of the second coordinate positions L2.

In the step S02, the touch position signal TS is transformed to a cursor position signal CSS. That is, after the touch position signal TS is generated, the coordinate transformation module 28 transforms the touch position signal TS to the cursor position signal CSS.

In the step S03, the cursor CS2 is displayed at a first coordinate position L1 corresponding to the second coordinate position L2 according to the cursor position signal CSS. That is, after the flat display module 26 receives the cursor position signal CSS, it displays the cursor CS2 at the first coordinate position L1 corresponding to the second coordinate position L2 according to the cursor position signal CSS.

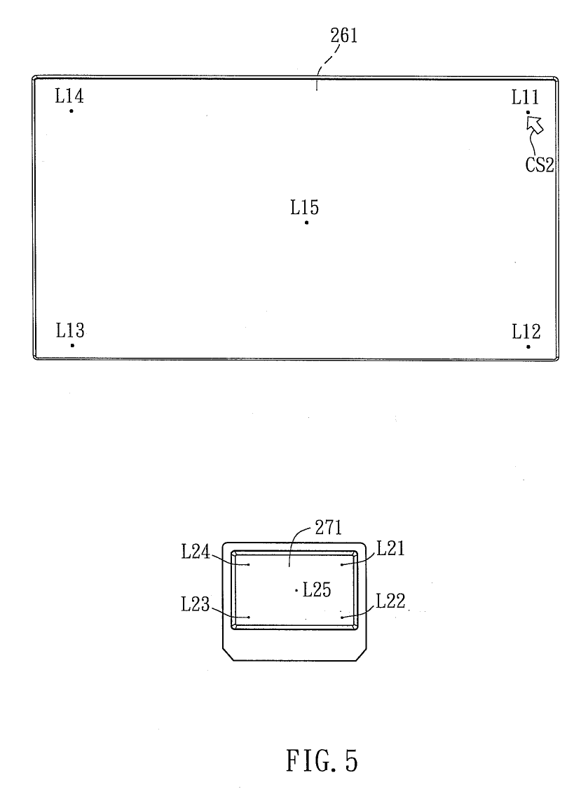

How to move the cursor CS2 to a needed position is illustrated with FIG. 5 hereinbelow. For example, the display area 261 has a plurality of first coordinate positions L11 to L15 (five coordinate positions are taken as an example), and the first coordinate positions L11 to L15 are corresponding to a plurality of second coordinate positions L21 to L25 of the touch pad 271, respectively. When the user wants to move the cursor CS2 to one of the first coordinate positions L11 to L15, he or she only needs to make his or her finger or an object touch one of the second coordinate positions L21 to L25 corresponding to the first coordinate positions L11 to L15. For example, when the user presses the second coordinate position L21, the cursor CS2 rapidly moves to the first coordinate position L11 no matter where the cursor CS2 is. The cursor CS2 can rapidly move to the first coordinate positions L12 to L15 in the same mode. Each of the second coordinate positions L2 of the touch pad 271 is corresponding to one of the first coordinate positions L1 of the display area 261. Numbers of the first coordinate positions L1 and the second coordinate positions L2 may be in direct proportion to the resolution (or sensitivity) of the touch pad module 27. That is, the numbers of the first coordinate positions L1 and the second coordinate positions L2 increase along with the increase of the resolution of the touch pad module 27.

In the embodiment, the touch pad module 27 may utilize a conventional touch pad module such as a capacitive touch pad module. However, the conventional capacitive touch pad module has limitation that it can only be operated by a finger.

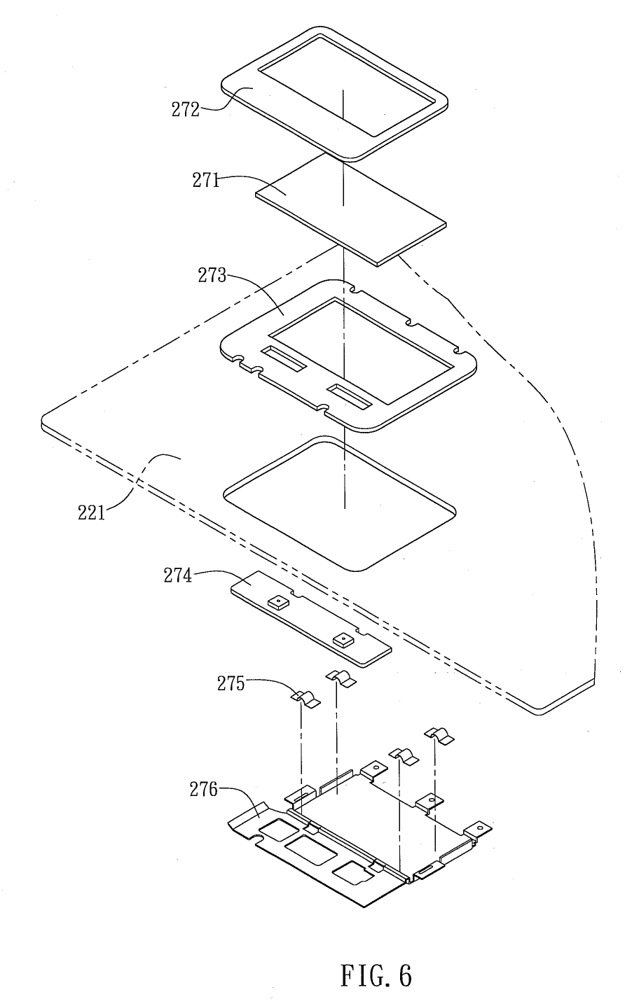

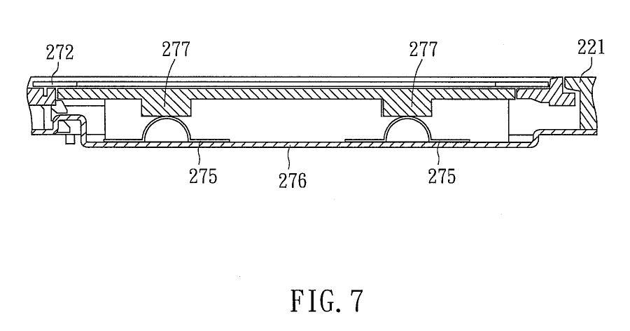

The function of the touch pad module 27 may be obtained by a plurality of sensing elements. FIG. 6 is an exploded diagram showing the touch pad module 27, and FIG. 7 is a sectional view showing the touch pad module 27. The touch pad module 27 includes a key sheet 272, a supporting ring 273, a key portion 274, a plurality of elastic elements 275, a supporting bracket 276 and a plurality of sensing elements 277. During the assembly, the supporting ring 273 is disposed at an upper casing 221 of the casing 22 first, and the touch pad 271 and the key portion 274 are disposed at the supporting ring 273. The sensing elements 277 are disposed at the inside of the touch pad 271 (as shown in FIG. 7). Then, the key sheet 272 is disposed on the supporting ring 273 to cover the key portion 274. Finally, the elastic elements 275 are disposed on the supporting bracket 276, and the supporting bracket 276 and the elastic elements 275 are disposed under the supporting ring 273. The elastic elements 275 are disposed to be opposite to the sensing elements 277.

When the user presses one of the second coordinate positions L2 of the touch pad 271, the four elastic elements 275 have different deformation, and the deformation causes resilience. Since the sensing elements 277 contact the elastic elements 275, each of the four sensing elements 277 can generate individual sensing information according to the resilience. In this way, the touch pad module 27 can generate a touch position signal according to the sensing information. In the embodiment, the elastic elements 275 may be springs, and the sensing elements 277 may be piezoelectric sensing elements.

In the embodiment, the four elastic elements 275 and the four sensing elements 277 are taken as an example. The numbers of the elastic elements 275 and the sensing elements 277 are not limited and may be in direct proportion to the resolution of the touch pad module 27. The type of the sensing elements 277 can be changed according to different design modes. For example, the sensing elements 277 may be photoelectric sensing elements (such as light emitting diodes, photoelectric crystal). When the user presses the touch pad 271, light quantity is changed. Then, the sensing elements 277 can generate individual sensing information, respectively, according to the light quantity, and the touch pad module 27 can generate a touch position signal according to the sensing information. In this way, the coordinate transformation module 28 can transform the touch position signal to the cursor position signal, and the cursor CS2 can be rapidly positioned according to the cursor position signal.

To sum up, in a portable device and a method for rapidly positioning a cursor of the invention, first coordinate positions of a display area are corresponding to second coordinate positions of a touch pad, and a coordinate transformation module is used to transform a touch position signal to a cursor position signal. In this way, when a user wants to move the cursor to a predetermined position, he only needs to press a position corresponding to the predetermined position on the touch pad, and then the cursor can be directly moved to the predetermined position. Compared with the conventional technology, the invention allows the user to rapidly position the cursor via the coordinate transformation module, and the user does not need to move his finger back and forth. Therefore, the usage performance increases. Furthermore, since the coordinate transformation module of the invention can transform a touch position to a cursor position, as for an electronic device, the size of the touch pad module does not need to be equal to the size of the flat display module. The size of the touch pad module may be smaller than the size of the flat display module to reduce the cost.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A portable device having a first area and a second area, the portable device comprising:
a flat display module disposed at the first area and having a display area, wherein the display area has a plurality of first coordinate positions, and a cursor is displayed at one of the first coordinate positions of the display area according to a cursor position signal;
a touch pad module disposed at the second area and having a touch pad, wherein the touch pad has a plurality of second coordinate positions, the first coordinate positions are corresponding to the second coordinate positions, respectively, according to the corresponding positions of the display area and the touch pad, and when the touch pad module senses that an object presses one of the second coordinate positions of the touch pad, the touch pad module generates a touch position signal; and
a coordinate transformation module transforming the touch position signal to the cursor position signal, wherein the flat display module displays the cursor at the first coordinate position corresponding to the pressed second coordinate position according to the cursor position signal.

2. The portable device according to claim 1, wherein the touch pad module further has a plurality of sensing elements disposed at the inside of the touch pad to sense that the object presses the touch pad further to generate a plurality of pieces of sensing information.

3. The portable device according to claim 2, wherein the touch position signal is generated according to the sensing information.

4. The portable device according to claim 2, wherein the sensing elements are selected from a group consisting of photoelectric sensing elements, piezoelectric sensing elements and combination thereof.

5. The portable device according to claim 1 further comprising two casings and a pivot unit, wherein the casings are pivotally connected to the pivot unit, and the first area and the second area are located at the casings, respectively.

6. The portable device according to claim 1, wherein the portable device is a notebook computer or a palmtop.

7. A method for rapidly positioning a cursor, wherein the method is applied to a portable device having a touch pad and a display area, the display area has a plurality of first coordinate positions, the touch pad has a plurality of second coordinate positions, and the first coordinate positions are corresponding to the second coordinate positions, respectively, according to the corresponding positions of the display area and the touch pad, the method comprising the steps of:
sensing the second coordinate position that an object presses at the touch pad to generate a touch position signal;
transforming the touch position signal to a cursor position signal; and
displaying the cursor at the first coordinate position corresponding to the second coordinate position according to the cursor position signal.

8. The method for rapidly positioning a cursor according to claim 7, wherein the step of sensing the second coordinate position that the object presses at the touch pad to generate the touch position signal further comprises the step of receiving a plurality of pieces of sensing information to generate the touch position signal.
